(19) United States
(12) Patent Application Publication
(10) Pub. No.: US 2026/0076871 A1
(43) Pub. Date: Mar. 19, 2026

(54) ACUPUNCTURE PAIN RELIEF DEVICE

(71) Applicant: Jianan Wang, Shenzhen, Guangdong (CN)

(72) Inventor: Jianan Wang, Shenzhen, Guangdong (CN)

(21) Appl. No.: 19/107,056

(22) PCT Filed: Sep. 7, 2023
(86) PCT No.: PCT/CN2023/117378

§ 371 Date: Feb. 27, 2025

(30) Foreign Application Priority Data
Sep. 30, 2022 (CN) 202211206670.X

(51) Int. Cl. A61H 39/08

(52) U.S. Cl. CPC A61H 39/086

(57) ABSTRACT

Provided is an acupuncture pain relief device, which comprises at least one conductive acupuncture needle and at least one capacitor; and the conductive acupuncture needle is conductively connected with the capacitor, so that free electrons can flow through the conductive acupuncture needle and be stored in the capacitor. This acupuncture pain relief device utilizes the characteristic that the capacitance of the capacitor is much larger than that of the human body of the acupuncturest, greatly improving the acupuncture analgesic effect; it uses the capacitance of the capacitor to replace the capacitance of the human body of the acupuncturest, greatly reducing the workload of the acupuncturest. Since this new acupuncture pain relief device can be inserted into the patient's acupoints for pain relief without time limitation, it can be used not only in hospital operations but also widely applied to alleviate the pain of patients, and has great market potential.

### TECHNICAL FIELD

This invention relates to an acupuncture device, especially an acupuncture pain relief device for improving the analgesic effect during acupuncture anesthesia, reducing the workload of acupuncturests, and widely used for alleviating pain in patients.

### BACKGROUND ART

The current hand needle acupuncture anesthesia is performed by the anesthesiologist with bare hands (without gloves) through continuous twisting and repeatedly lifting and inserting metal acupuncture that has been pierced into the patient's special acupoints. Because the bare hand (without gloves) twisting the metal needle ensures that the metal needle is electrically connected to the anesthesiologist's hand, and because the human body is equivalent to a capacitor, the physics of acupuncture anesthesia is achieved by inserting conductive acupuncture needles into the patient's specific acupoints to neutralize the charge of charged ions that collect in the patient's acupoints. If the patient's acupoint is negatively charged, the conductive acupuncture needle will export electrons from the patient's acupoint to the anesthesiologist's body to neutralize the negative charge of the patient's acupoint; If the patient's acupoint is positively charged, the conductive acupuncture needle will export electrons from the anesthesiologist's body to the patient's acupoint to neutralize the positive charge of the patient's acupoint. The continuous neutralization of the electric charge carried by the patient's acupoint can weaken or eliminate the electric current (action potential pulse) generated from the patient's pain point and flowing through the nervous system to the brain via the acupoint, thereby achieving the goal of reducing or eliminating the patient's pain.

This acupuncture anesthesia method has the following defects:
1. The conductivity between the acupuncture anesthesiologist's hand and the metal acupuncture needle is not good enough. This is because, compared with the conductivity of the welded or contact point between a metal wire and a metal needle, the conductivity of the contact point between the skin of the hand and the metal needle is not high.
2. The contact quality between the acupuncture anesthesiologist's hand and the metal acupuncture needle cannot be guaranteed. Although the anesthesiologist holds the metal acupuncture needle with bare hands (without gloves), it is difficult to ensure the contact quality between the skin of the hand and the metal acupuncture needle (related to the force with which the anesthesiologist holds the needle and the electrical conductivity of the anesthesiologist's finger skin. The greater the force of holding the needle, the larger the contact area between the finger and the needle).
3.The electrical capacitance of the acupuncture anesthesiologist's body is not large enough. Although the human body has capacitance (the human body capacitance is about 100 pF), it is too small compared to capacitors (the electrical capacitance of a small ceramic capacitor can reach 100,000 pF). The larger the electrical capacitance of the anesthesiologist's body, the better the effect (anesthesia effect) of neutralizing the charge carried by the patient's acupoint through the acupuncture needle.
4. The acupuncture anesthesiologist cannot manipulate the needles continuously for 24 hours, so acupuncture anesthesia, in addition to being used for short-duration surgeries, cannot help those patients who suffer from pain for long periods to alleviate their pain.

### SUMMARY OF THE INVENTION

### Technical Problems

The technical problem to be solved by the invention is to overcome the deficiencies of the existing technologies, and to provide an acupuncture pain relief device that can reduce the workload of acupuncturats, enhance the effect of acupuncture in relieving pain, and be widely used for alleviating patients'pain.

### Technical Solutions

The invention solves the problem through the following technical solution.

This acupuncture pain relief device comprises at least one conductive acupuncture needle, characterized in that it further comprises at least one capacitor; and the conductive acupuncture needle is conductively connected with the capacitor, so that electrons can flow from the acupoint of the patient through the conductive acupuncture needle and be stored in the capacitor, or flow out from the capacitor and be released at the acupoint of the patient through the conductive acupuncture needle.

The technical problems of the acupuncture pain relief device of the invention are further solved by the following technical solutions.

The conductive acupuncture needle and the capacitor are separately connected.

The conductive acupuncture needle and the capacitor are separately connected through a wire.

An acupuncture pain relief device, comprising at least one conductive acupuncture needle, characterized in that: it further comprises a capacitor consisting of at least one large-sized capacitor, each large-sized capacitor is provided with at least one pair of positive and negative electrode leads, and the negative electrode lead is connected with one conductive acupuncture needle through a wire.

The positive electrode lead on the capacitor is connected to a metal plate that fits against the human body through a wire.

The conductive acupuncture needle is made of metal, alloy or high-temperature superconducting ceramic material.

### Beneficial Effects

The beneficial effects of the acupuncture pain relief device of this invention in comparison with the existing technology are as follows: This acupuncture pain relief device scientifically applies the capacitor in acupuncture analgesia, and utilizes the characteristic that the capacitance of the capacitor is much larger than that of the human body of the acupuncturest, greatly improving the acupuncture analgesic effect and reducing the pain sensation of the patient; by using the capacitance of the capacitor to replace the capacitance of the human body of the acupuncturest, the workload of the acupuncturest is greatly reduced. Since the acupuncture pain relief device of this invention can be inserted into the patient's acupoint for pain relief without time limitation (such as continuous multi-day 24-hour uninterrupted), the acupuncture pain relief device of this invention can be used not only in hospital surgery, but also can be widely used to alleviate the pain of patients (such as cancer patients, toothache patients), and has great market potential. The specific structure of the acupuncture pain relief device of this invention is given in detail by the following figures and embodiments.

### BRIEF DESCRIPTION OF THE DRAWINGS

FIG. 1 is a schematic diagram of the structure of the acupuncture pain relief device;

FIG. 2 is a schematic diagram of the structure of embodiment 1 of the acupuncture pain relief device;

FIG. 3 is a schematic diagram of the structure of embodiment 2 of the acupuncture pain relief device;

FIG. 4 is a schematic diagram of the structure of embodiment 3 of the acupuncture pain relief device.

### DETAILED DESCRIPTION OF THE BEST EMBODIMENT OF THE INVENTION

### Embodiment 1

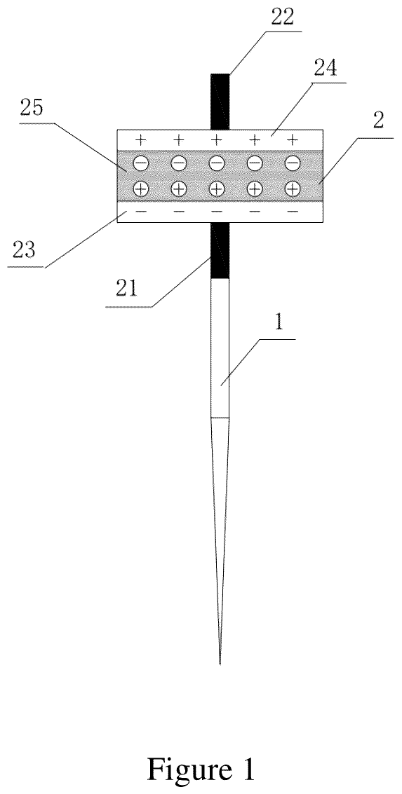

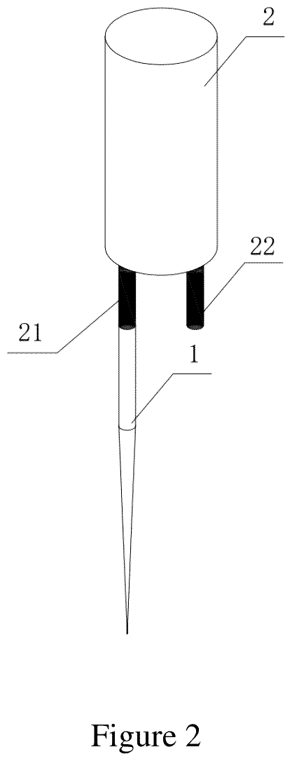

The acupuncture pain relief device, as shown in FIGS. 1 and 2, consists of a conductive acupuncture needle 1 and a small capacitor 2.

The conductive acupuncture needle 1 is made of a metal material.

The capacitor 2 is composed of a positive conductive plate 23, a negative conductive plate 24 and an insulating dielectric plate 25 sandwiched between the two conductive plates (as shown in FIG. 1), and metal lead wires 21 and 22 are respectively welded on the positive and negative conductive plates.

In order to achieve as large a capacitance as possible within a minimal space, the plates 23 and 24 of the capacitor 2, along with the insulating dielectric plate 25 sandwiched between them, are rolled up together into a cylinder as shown in FIG. 2.

The non-needle tip of the conductive acupuncture needle 1 is welded and connected with the anode plate lead 21 of the capacitor 2 (the non-needle tip of the conductive acupuncture needle 1 can also be directly welded and connected with the anode plate of the capacitor 2), so that free electrons can flow through the conductive acupuncture needle 1 and be stored in the capacitor 2, or flow out from the capacitor 2 and be released to the outside through the conductive acupuncture needle 1.

The capacitance of the capacitor 2 is 1000 pf.

Since the capacitor 2 is a small-sized capacitor, it will not affect the convenience of the acupuncturest's use of the needle after being welded and integrated with the conductive acupuncture needle 1. During use, just insert the conductive acupuncture needle 1 with the capacitor 2 welded into the patient's acupoint according to the normal acupuncture method. Based on the fact that the capacitance of the capacitor 2 (1000 pf) is much larger than the capacitance of the acupuncturist's body (100 pf), when the conductive acupuncture needle 1 of this device punctures the corresponding acupoint of the patient, the charge of the ions gathered at the acupoint will be neutralized in a timely manner. If the acupoint is negatively charged, the conductive acupuncture needle 1 exports electrons from the acupoint to the capacitor 2 to neutralize the negative charge of the acupoint; If the acupoint is positively charged, the conductive acupuncture needle 1 exports electrons from the capacitor 2 to the acupoint to neutralize the positive charge of the acupoint. Therefore, the action potential current pulse generated by the patient's pain point will be greatly weakened or eliminated when it flows through the patient's neural network, thus greatly reducing the intensity of the action potential current pulse generated by the patient's pain point into the patient's brain through the neural network, that is, greatly reducing the patient's pain. Since the capacitance of the capacitor 2 is used instead of the capacitance of the acupuncturest's body, this acupuncture pain relief device, after being inserted into the patient's acupoint, no longer requires the acupuncturest to manipulate the needle. Therefore, it can be continuously inserted into the patient's acupoint to relieve pain without any time limitation (such as uninterruptedly for multiple days and 24 hours). Since this acupuncture pain relief device is small in size and light in weight, and can move together with the patient, the patient can maintain his normal life and work while relieving pain. Therefore, this product is very useful for patients with toothache, cancer patients and other patients who have suffered from pain for a long time to eliminate or relieve pain.

### Detailed Description of the Embodiments of the Invention

### Embodiment 2

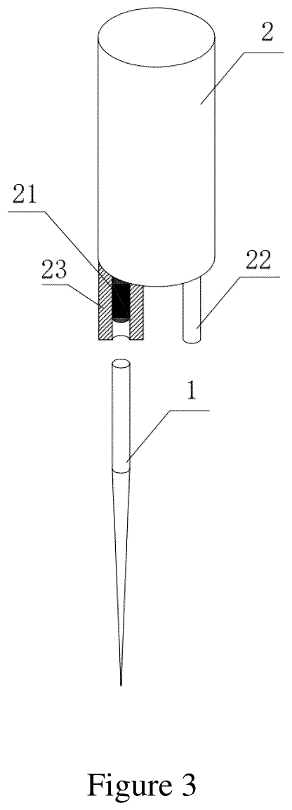

As can be clearly seen from FIG. 3, the basic structure of the acupuncture pain relief device is the same as that of Embodiment 1, and is composed of a conductive acupuncture needle 1 and a small capacitor 2. The difference is that: in order to facilitate the acupuncturest's needle insertion, there is a plug connection (separable connection) between the conductive acupuncture needle 1 and the capacitor 2. As shown in FIG. 3, a metal connector 23 is welded on the positive plate lead 21 of the capacitor 2. After inserting the non-needle tip end of the conductive acupuncture needle 1 into the metal connector 23, it can be electrically connected to the positive plate lead 21. After the conductive acupuncture needle 1 is separated from the metal connector 23, it can be disconnected from the capacitor 2. When using this type of acupuncture pain relief device, the conductive acupuncture needle 1 can be first separated from the capacitor 2, then insert the conductive acupuncture needle 1 into the patient's acupoint, and after that, insert the non-needle tip end of the conductive acupuncture needle 1 into the metal connector 23 of the capacitor 2.

### Embodiment 3

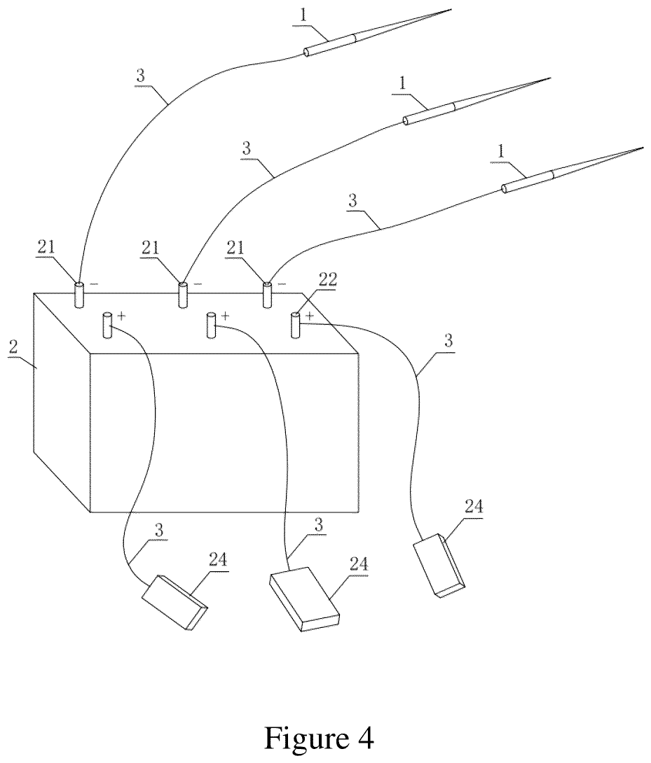

As shown in FIG. 4, this is an acupuncture pain relief device composed of multiple conductive acupuncture needles 1 and multiple large capacitors 2. The capacitance of each large capacitor 2 is 10000 uf. Each large capacitor is provided with a pair or more of positive and negative plate leads 21 and 22, and multiple large capacitors are installed in a box to form a capacitor group. Each of the conductive acupuncture needles 1 is equipped with a wire 3 connected to the positive plate lead 21 of each capacitor 2 respectively. Both ends of the wire 3 are provided with metal clips (not shown in the figure) that can be easily connected to the capacitor plate leads and the non-needle tip end of the conductive acupuncture needle 1. After each conductive acupuncture needle 1 is connected to the positive plate lead 21 of each capacitor 2 through the wire 3, it can enable the free electrons in the acupoint inserted by the conductive acupuncture needle to flow through the conductive acupuncture needle 1 and be stored in the capacitor 2, or enable the free electrons to flow out of the capacitor 2 and be released at the acupoint inserted by the conductive acupuncture needle through the conductive acupuncture needle. As the capacitor 2 is composed of multiple large-capacity capacitors, it has a better pain relief effect and can be used for surgical anesthesia in hospitals. When using, first insert multiple conductive acupuncture needles 1 into different acupoints of the patient according to the normal acupuncture method. Then clip a metal clip at one end of each wire 3 onto each conductive acupuncture needle 1, and clip the other end of each wire 3 onto each positive plate lead 21 of the capacitor 2. In this way, the electrons of the negative ions accumulated in the patient's acupoints will be drawn out by the conductive acupuncture needles 1, flow through the connecting wires 3, and be stored in the capacitor 2; the positive ions accumulated in the patient's acupoints will be neutralized by the free electrons released from the capacitor 2 through the conductive acupuncture needles 1; so as to achieve the purpose of pain relief.

The negative plate leads 22 of the capacitor 2 are connected to a metal sheet 24 through wires 3. During acupuncture, the metal sheet 24 is stuck to the patient's body with tape. In this way, the free electrons of the negative plate of the capacitor 2 can flow into the patient's body, and the electrons on the patient's body can also flow into the negative plate of the capacitor 2, so as to achieve better electricity storage effect of the capacitor 2.

Since there are various types of capacitors with different structures besides the one presented in the above embodiment, and their functions are the same, the capacitor described in this invention is not limited to this type. The above contents are further detailed descriptions of the invention in combination with specific preferred implementation examples, and it cannot be assumed that the specific implementation of the invention is limited to these descriptions. For ordinary technicians in the technical field to which the invention belongs, the architecture form can be flexible and changeable, and a series of products can be derived without deviating from the concept of the invention. Any simple deduction or substitution shall be deemed to fall within the scope of patent protection of the invention as determined by the claims submitted.

1. An acupuncture pain relief device, comprising: at least one conductive acupuncture needle, wherein the device further comprises at least one capacitor; the non-needle tip end of the conductive acupuncture needle is conductively connected to the capacitor, such that free electrons are capable of flowing through the conductive acupuncture needle and being stored in the capacitor.

2. The acupuncture pain relief device according to claim 1, wherein the conductive acupuncture needle and the capacitor are separably connected to each other.

3. The acupuncture pain relief device according to claim 1, wherein the conductive acupuncture needle and the capacitor are separately connected through a wire.

4. (canceled)

5. (canceled)

6. (canceled)

7. The acupuncture pain relief device according to claim 2, wherein the conductive acupuncture needle and the capacitor are separately connected through a wire.

8. The acupuncture pain relief device according to claim 1, wherein the conductive acupuncture needles are made of metal, alloy or high-temperature superconducting ceramic materials.

9. The acupuncture pain relief device according to claim 2, wherein the conductive acupuncture needles are made of metal, alloy or high-temperature superconducting ceramic materials.

10. The acupuncture pain relief device according to claim 3, wherein the conductive acupuncture needles are made of metal, alloy or high-temperature superconducting ceramic materials.

11. An acupuncture pain relief device comprises at least one conductive acupuncture needle, wherein the device further comprises at least a capacitor formed by at least one large capacitor, each large capacitor is provided with at least a pair of positive and negative lead wires, and the negative lead wire thereof is connected with one conductive acupuncture needle through a lead wire.

12. The acupuncture pain relief device according to claim 11, wherein the positive lead wire on the capacitor is connected to a metal plate that fits against the human body through a wire.

13. The acupuncture pain relief device according to claim 11, wherein the conductive acupuncture needles are made of metal, alloy or high-temperature superconducting ceramic materials.

14. The acupuncture pain relief device according to claim 12, wherein the conductive acupuncture needles are made of metal, alloy or high-temperature superconducting ceramic materials.
